(19) United States
(12) Patent Application Publication
(10) Pub. No.: US 2009/0303630 A1
(43) Pub. Date: Dec. 10, 2009

(54) METHOD AND APPARATUS FOR HARD DISK POWER FAILURE PROTECTION

(75) Inventor: Yu Zhou, ShenZhen City (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: H3C TECHNOLOGIES CO., LTD., Hangzhou, Zhejiang (CN)

(21) Appl. No.: 12/413,859

(22) Filed: Mar. 30, 2009

(30) Foreign Application Priority Data
Jun. 10, 2008 (CN) 200810111146.8

(51) Int. Cl. G11B 5/02

(52) U.S. Cl. 360/55; G9B/5.026

(57) ABSTRACT

The present invention relates to a method and an apparatus for hard disk power failure protection. The method includes receiving power from a battery through a battery power input wire when the hard disk drive is out of power, supplying battery power to the cache of the hard disk drive, and performing data protection for the cache. A wire of the hard disk interface (HDI) may be set as the battery power input wire, and the battery power voltage is less than or equal to the standard voltage of the wire used as the battery power input wire. The method can ensure cache data security and integrity with low cost and maintain compatibility with existing interface configurations.

### CROSS-REFERENCE TO RELATED APPLICATIONS

The present application claims priority to Chinese Patent Application CN 200810111146.8 filed in the PRC Patent Office on Jun. 10, 2008, the entire contents of which is incorporated herein by reference.

### BACKGROUND

1. Field of the Invention

This invention relates to a method, an apparatus, and a system for providing hard disk power failure protection and a type of hard disk drive.

2. Description of the Related Art

Power failure protection technology is widely adopted by systems that require high reliability and availability. It avoids problems such as data loss by supplying power to a system when an abnormal power failure occurs.

For example, an uninterruptible power supply (UPS) can supply power to a system that has high data reliability requirements when utility power is interrupted.

A Chinese patent application numbered CN101183801A describes a solution that avoids memory data loss when utility power is not available by supplying power from a backup battery unit (BBU) to the memory, the memory controller and the non-volatile memory.

However, current power failure protection solutions are all designed for the whole system. There are no specific power failure protection solutions for hard disk drives. Hard disk drives are commonly used storage devices in computers and telecommunication equipment. They use an internal electrical motor to move the read and write heads, which cannot provide high read/write speed. To solve this problem, vendors embed memories, usually volatile memories such as dynamic random access memories (DRAMs) in hard disk drives as data read/write caches. When a power failure occurs, data in the cache will be lost because it has not been actually flushed to the hard disk. This is fatal to systems that require high reliability.

Although some solutions can provide power failure protection for hard disk drives, by using a UPS for example, they are not designed for hard disk drives specifically and thus have these drawbacks:

1. If a system has many hard disk drives installed, it has to be equipped with a high-power UPS or many standard UPSs, which cost a lot.

2. UPSs need a large space for installation, which brings difficulties in design and implementation.

As is apparent, there is no specific, efficient power failure protection solution for hard disks.

### SUMMARY

The objective of the present invention is to provide an effective hard disk power failure protection solution that features low cost and high reliability, and ensures data security in the hard disk cache.

To achieve the objective, the technical proposal of the present invention comprises:

A method for providing hard disk power failure protection, comprising:

S1. receiving power from the battery through the preset battery power input wire when the hard disk drive is detected out of power;

S2. supplying battery power to the disk cache and performing data protection for the cache.

An apparatus for hard disk power failure protection, comprising:

a hard disk power monitoring unit, which monitors hard disk power and triggers the hard disk cache protection unit upon detection of a power failure;

a hard disk cache protection unit, which supplies power from the connected battery supply to the hard disk cache upon receiving power failure signals from the power monitoring unit and performs data protection for the cache.

A type of hard disk drive, comprising a hard disk and a disk controller, wherein the controller comprises the hard disk cache and is where the hard disk power failure protection apparatus is located; the hard disk power failure protection apparatus is connected to the external battery supply through the preset battery power input wire of the controller.

A hard disk power failure protection system, comprising a battery supply and a hard disk drive mentioned above, wherein the hard disk drive is connected to the battery supply through the preset battery power input wire. Using a battery supply to provide power for the hard disk cache, the present invention has the following advantages:

1. Protecting the data in disk cache in a low cost, highly reliable way;

2. Be compatible with the existing hard disk connector by connecting the hard disk to the battery supply through a wire of the existing HDI (hard disk interface).

The objectives, features and advantages of the present invention are manifested in the detailed description of the embodiments of the present invention in conjunction with drawings.

### BRIEF DESCRIPTION OF THE SEVERAL VIEWS OF THE DRAWINGS

FIG. 1 is a flow chart of implementing the hard disk power failure protection method according to an embodiment of the present invention.

FIG. 2A, FIG. 2B and FIG. 2C are preferable flow charts of implementing the method illustrated in FIG. 1.

FIG. 3 is a block diagram of the hard disk power failure protection apparatus according to an embodiment of the present invention.

FIG. 4A and FIG. 4B are block diagrams of two embodiments of hard disk cache protection unit 102 according to the present invention.

FIG. 5 is a block diagram of a hard disk drive embodiment of the present invention.

FIG. 6 is a schematic diagram illustrating a SAS hard disk interface (HDI) according to an embodiment of the present invention.

FIG. 7 is a block diagram of a hard disk power failure protection system according to an embodiment of the present invention.

### DETAILED DESCRIPTION

The following embodiments of the present invention are for illustration only and are not for restricting the present invention.

The idea of this invention is to use a battery supply to provide power for the circuits of the hard disk cache when the system is out of power for data protection. In current solutions, such as using a dedicated backup battery unit (BBU) to supply power to a hard disk drive, additional power failure protection circuits and battery units need to be added to the hard disk drive, which brings design difficulties, increases the size of the hard disk drive and affects usage. To avoid such problems, the present invention uses a battery power input wire to receive power from the battery supply.

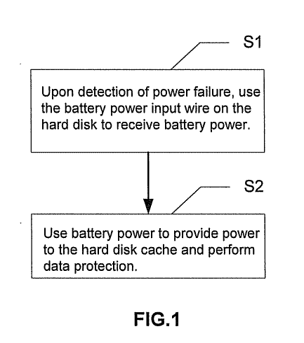

FIG. 1 is the flow chart of an embodiment implementing the hard disk power failure protection method of the present invent, comprising:

S1. receiving power from the battery supply through the preset battery power input wire of the hard disk drive when the disk drive is out of power;

S2. supplying battery power to the disk cache and performing data protection for the cache;

Since the battery only needs to provide power for the cache circuits with low power consumption rather than for all circuits of the hard disk drive, its effective operating time can be ensured without a UPS.

To further ensure the effectiveness of the battery, it can be monitored during operation. Once its power goes below a threshold, the battery is recharged or a prompt of replacing the battery appears.

Steps S1 and S2 ensure cache data security during power failure to provide high data reliability at low cost, improving the performance-to-cost ratio of the system.

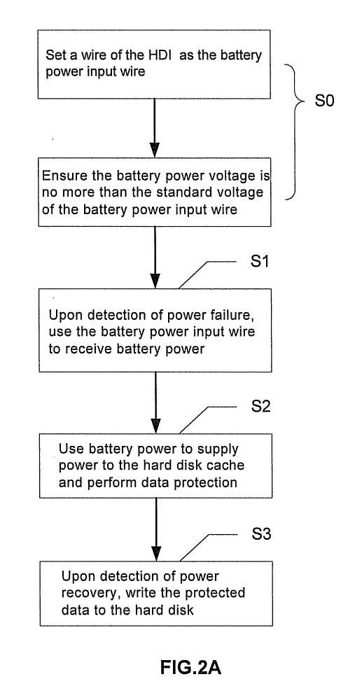

FIG. 2A shows the flow chart of a preferable embodiment of the present invention. Compared to the embodiment shown in FIG. 1, the flow chart further comprises step S3, which allows writing the protected data to the hard disk by using utility power after utility power recovery. The whole cache data protection process is as follows:

The monitoring circuit, upon detection of a power failure, generates power failure signals.

The circuit receiving the power failure signals performs data protection with power from the battery.

The monitoring circuit, upon detection of utility power recovery, generates power recovery signals.

The circuit receiving the power recovery signals writes the protected data to the hard disk.

Wherein, a separate battery power input wire can be set. For example, the vendor can set a dedicated battery power input interface on the hard disk, or add a battery power input wire in the existing HDI.

Considering hardware compatibility, however, it is preferable to further comprise step S0 before step S1 to set a wire of the existing HDI as the battery power input wire. In this way, the hard disk drive is connected to the battery without the need of adding a dedicated wire. The hard disk drive connects to the utility power supply through another interface wire. When a power failure occurs, battery power replaces utility power to implement cache data protection.

To ensure hard disk power compatibility, step S0 further comprises keeping the battery power voltage less than or equal to the standard voltage of the battery power input wire on the hard disk drive. This ensures that the battery voltage does not affect the normal operation of the hard disk drive regardless of whether the hard disk drive is using the battery power for power failure protection. If the battery voltage is not enough to support the operation of the cache, for example, the battery voltage is 3.3 V while the cache needs 5 V voltage, a voltage transformation circuit can be added at the input end of the battery power input wire.

Wherein, as different interfaces adopt different standards, parameters considered during battery power input wire selection and voltage design vary with interface types.

Wherein, the HDI can be one of these types: Advanced Technology Attachment (ATA), Serial Advanced Technology Attachment (SATA), Serial Attached SCSI (SAS), Small Computer System Interface (SCSI) or Fiber Channel (FC). Among them, ATA is also called Integrated Drive Electronics (IDE).

Suppose the P1 wire of the SAS HDI is set as the battery power input wire. The following table shows the pinout of the interface.

TABLE 1

| | | Backplane | SAS Drive plug and |
|---|---|---|---|
| Segment | Pin | receptacle | SAS Drive cable receptacle |
| Primary signal | S1 | SIGNAL GROUND | |
| segment | S2 | TP+ | RP+ |
| | S3 | TP− | RP− |
| | S4 | SIGNAL GROUND | |
| | S5 | RP− | TP− |
| | S6 | RP+ | TP+ |
| | S7 | SIGNAL GROUND | |
| Secondary signal | S8 | SIGNAL GROUND | |
| segment^{a} | S9 | TS+ | RS+ |
| | S10 | TS− | RS− |
| | S11 | SIGNAL GROUND | |
| | S12 | RS− | TS− |
| | S13 | RS+ | TS+ |

| | | |
|---|---|---|
| | S14 | SIGNAL GROUND |
| Power segment^{b} | P1 | V₃₃^{c} |
| | P2 | V₃₃^{c} |
| | P3 | V₃₃ precharge^{c} |
| | P4 | GROUND |
| | P5 | GROUND |
| | P6 | GROUND |
| | P7 | V₅ precharge^{c} |
| | P8 | V₅^{c} |
| | P9 | V₅^{c} |
| | P10 | GROUND |
| | P11 | READY LED^{d} |
| | P12 | GROUND |
| | P13 | V₁₂ precharge^{c} |
| | P14 | V₁₂^{c} |
| | P15 | V₁₂^{c} |

As defined in the SAS protocol, the voltage of the P1 wire complies with the V33 standard. Therefore, to keep the battery compatible with the current system, the battery voltage should be in the range defined in V33. When the P1 wire is not used as the battery power input wire (for example, the hard disk is a standard one or it does not suffer a power failure), the P1 wire still acts as a V33 input wire. Thus the battery power does not affect the normal operation of the hard disk.

FIG. 2B and FIG. 2C show the work flows of two embodiments of the present invention that use different protection methods.

Wherein, in one method, the cache (DRAM, for example) enters self-refreshing state during a power failure; after power recovery, the data in the cache is written to the hard disk. That is, step S2 comprises supplying battery power to the cache and keeping the cache in self-refreshing state; step S3 comprises writing the protected data in the cache to the hard disk after power recovery.

In the other method, the data in the cache is written to a non-volatile memory (flash, or EEPROM) by using battery power during a power failure; after power recovery, the data in the non-volatile memory is written to the hard disk. That is, step S2 comprises writing the data in the cache to the non-volatile memory by using battery power; step S3 comprises writing the data in the non-volatile memory to the hard disk after power recovery.

These two methods are for illustration only. Technical persons in this field may adopt other different cache data protection measures.

The technical persons in this field can understand that some or all steps above mentioned can be performed by hardware through program instructions. The program can be stored in a computer readable storage medium and its instructions comprise:

S1. receiving power from the battery through the battery power input wire when the hard disk drive is out of power;

S2. supplying battery power to the cache of the hard disk drive and performing data protection for the cache.

Wherein, the storage medium can be a Read Only Memory/Random-Access Memory (ROM/RAM), a diskette or a CD.

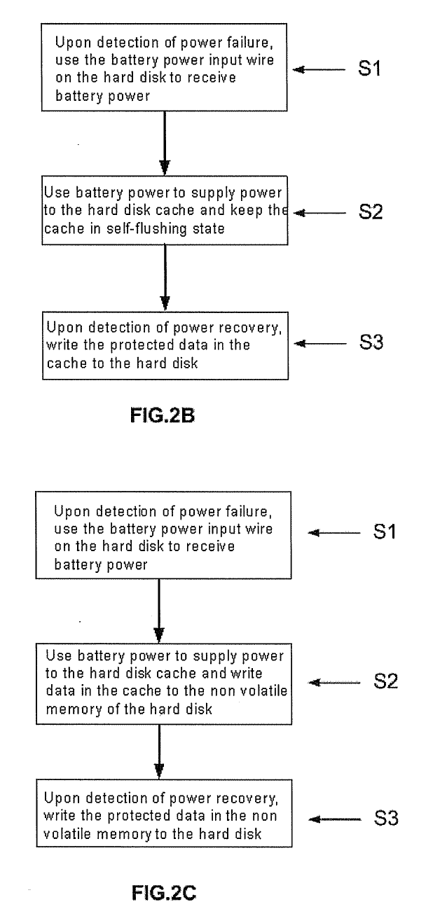

The present invention also provides hard disk power failure protection apparatus 100, which as shown in FIG. 3 resides in the hard disk drive and comprises:

hard disk power monitoring unit 101, which monitors hard disk power and triggers hard disk cache protection unit 102 upon detection of a power failure;

hard disk cache protection unit 102, which supplies power from the battery connected to it through the pre-set battery power input wire to the hard disk cache upon receiving power failure signals from power monitoring unit 101 and performs data protection for the cache.

This apparatus ensures cache data security during a power failure to provide high reliability at low cost, improving the performance-to-cost ratio of the system.

Preferably, hard disk power monitoring unit 101, upon detection of utility power recovery, notifies the event to hard disk cache protection unit 102, which then disconnects from the battery, connects to the utility power supply and writes the protected data to the hard disk using utility power.

Hard disk power monitoring unit 101 provides both power failure and power recovery circuits for monitoring utility power and signals detected power failures and power recoveries to hard disk cache protection unit 102. Hard disk cache protection unit 102, upon receiving power failure signals, performs data protection to put the cache in self-refreshing state or write the data in the cache to a non-volatile memory, and upon receiving power recovery signals, writes the protected data into the hard disk. During this process, hard disk cache protection unit 102 performs power switchover. As technical persons in this field are familiar with power switchover methods such as pin swapping, these methods are not described here.

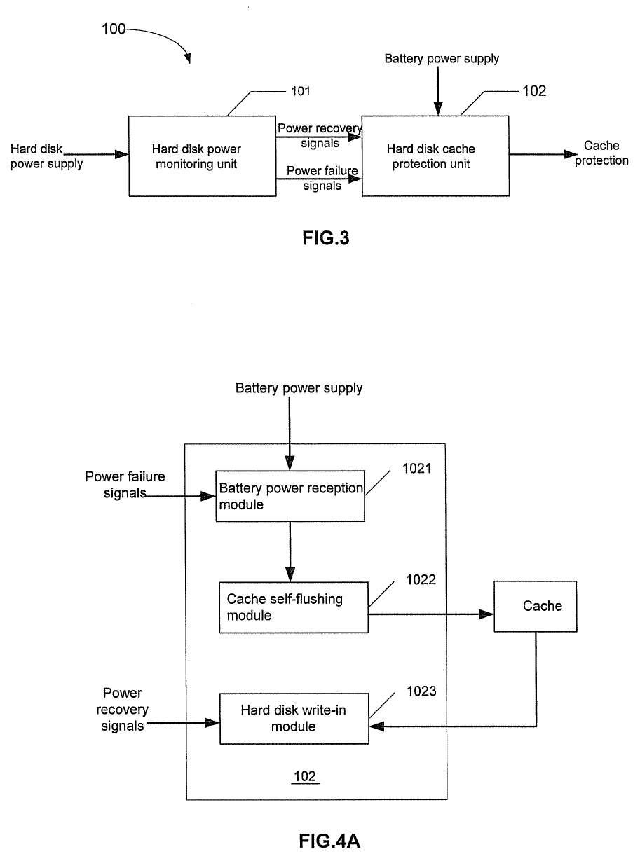

The embodiment of hard disk cache protection unit 102 as shown in FIG. 4A implements cache data protection by placing the cache in self-refreshing state. It comprises:

battery power reception module 1021, which starts to receive power from the battery through the battery power input wire upon receiving power failure signals. Note that if the battery power supply is not enabled on battery power reception module 1021 during the power failure, it stays in the waiting or charge state;

cache self-refreshing module 1022, which supplies battery power to the cache and keeps the cache stay in self-refreshing state;

hard disk write-in module 1023, which writes the data in the cache into the hard disk upon receiving power recovery signals.

The embodiment of hard disk cache protection unit 102 as shown in FIG. 4B implements cache data protection by writing the data in the cache to a non-volatile memory. It comprises:

battery power reception module 1021, which starts to receive power from the battery through the battery power input wire upon receiving power failure signals;

non-volatile memory 1024;

cache data modify module 1025, which supplies battery power to the cache and non-volatile memory 1024, and writes the data in the cache into the non-volatile memory (that is, cache data modify operation);

hard disk write-in module 1023, which writes the data in the non-volatile memory into the hard disk upon receiving power recovery signals.

Preferably, for compatibility with the current system, one wire of the existing HDI can be used as the battery power input wire for hard disk cache protection unit 102; the voltage of the battery supply must be less than or equal to the standard voltage of the battery power input wire. Another HDI wire is used to connect to the utility power supply. The type of the HDI can be ATA, SATA, SAS, SCSI or FC.

If the battery power supply cannot support the operation of the cache due to the voltage restriction of the battery power input wire, hard disk cache protection unit 102 uses a voltage transformation circuit (not illustrated in the figure) to increase the battery power voltage before supplying battery power to the cache.

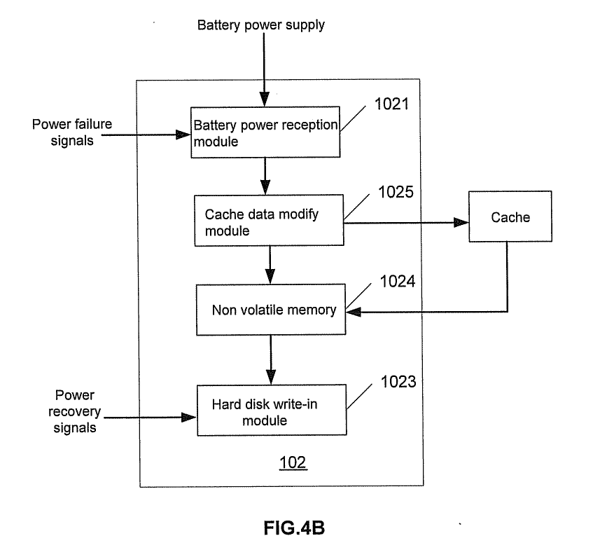

The present invent also provides hard disk drive 10, which has the power failure protection capability, as shown in FIG. 5. It comprises hard disk 12, and hard disk controller 11, which further comprises hard disk cache 110. Hard disk power failure protection apparatus 100 is placed in hard disk controller 11 and is connected to the batter power supply through battery power input wire 13 on hard disk controller 11.

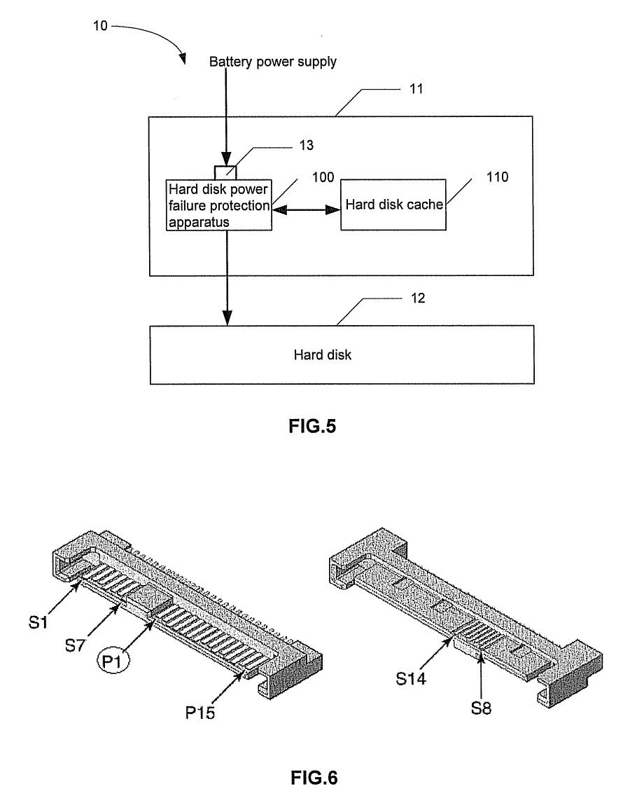

Preferably, for compatibility between the hard disk controller and the existing hard disk connector interface, a wire of the HDI is used as battery power input wire 13. The voltage of the battery supply must be less than or equal to the standard voltage of the battery power input wire to ensure that the cache data can be used reliably. Hard disk 10 uses another HDI wire to receive utility power when operating normally.

Wherein, the HDI can be an ATA, SATA, SAS, SCSI or FC interface. In practice, the designer should select battery power input wire 13 according to the hard interface type and application requirements. For example, set the P1 wire of a SAS interface as the battery power input wire. FIG. 6 shows the pin pattern layout of the SAS interface. Refer to Table 1 for the pinout of the SAS interface.

Thus, by using the existing HDI to receive battery power, hardware compatibility with the existing hard disk connector is achieved.

Note that when the pinout of the HDI is changed, the pinout of the hard disk cable, or rather, the hard disk connector, can be adapted to the change. The way it is adapted varies with interface types (ATA, SATA, SAS, SCSI and FC), and is not described here.

The hard disk connector can still work even if its pinout is not adapted, so long as the battery voltage is within the voltage range defined by the interface protocol.

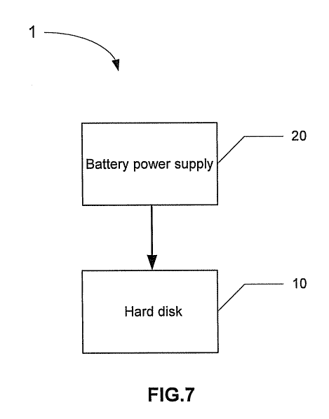

The present invention also provides hard disk power failure protection system 1, as shown in FIG. 7. It comprises battery power supply 20 and hard disk drive 10, which are connected through battery power input wire 13. Utility power, when available, is used for writing data from the cache to the hard disk. When utility power is not available, battery power supply 20 provides power for the cache to implement data protection.

Preferably, hard disk drive 10 can use the existing hard disk interface to receive power from battery power supply 20. The voltage of battery power supply 20 must be less than or equal to the standard voltage of the wire used for the battery power input wire or the output end of the HDI. For example, if the P1 wire of the SAS interface is set as battery power input wire 13, the voltage of battery power supply 20 should be in the voltage range defined in the interface protocol. If the pinout shown in Table 1 is used, the battery voltage should be less than or equal to 3.3 V.

Although several embodiments of the invention and their advantages are described in detail, a person skilled in the art could make various alternations, additions, and omissions without departing from the spirit and scope of the present invention as defined by the appended claims.

What is claimed is:

1. A method for preventing data loss in a hard disk during a power failure event, comprising:
detecting a power failure event that prevents power from reaching at least a portion of the hard disk;
receiving power from a battery through a battery power input wire during the power failure event; and
supplying the power from the battery to a hard disk cache portion of the hard disk to maintain an integrity of data stored in the cache.

2. The method of claim 1, wherein the hard disk has a hard disk interface (HDI) that conforms to an industry standard, and wherein one of the wires of the industry standard HDI is utilized as the battery power input wire, and wherein a battery power voltage placed on the battery power input wire is less than or substantially equal to a voltage of the input wire as defined by the industry standard.

3. The method of claim 2, wherein the industry standard HDI is an Advanced Technology Attachment (ATA), Serial Advanced Technology Attachment (SATA), Small Computer System Interface (SCSI), Serial Attached SCSI (SAS), or Fiber Channel (FC) interface.

4. The method of claim 1, further comprising writing the data from the cache to the hard disk when an end to the power failure event is detected.

5. The method of claim 1, wherein maintaining the integrity of the data stored in the cache comprises either keeping a self-refreshing state of the hard disk cache active or writing the data in the cache to a separate non-volatile memory.

6. The method of claim 5, further comprising detecting an end to the power failure event and writing the data in the cache or the data copied to the non-volatile memory to the hard disk.

7. An apparatus for hard disk power failure protection, comprising:
a hard disk power monitoring unit that monitors hard disk power and triggers a hard disk cache protection unit upon detection of a power failure event that prevents power from reaching at least a portion of the hard disk,
wherein the hard disk cache protection unit supplies power from a connected battery supply to the hard disk cache upon receiving a power failure signal from the power monitoring unit and performs data protection for the cache.

8. The apparatus of claim 7, wherein the hard disk power monitoring unit, upon detection of an end to the power failure event, signals the hard disk cache protection unit to write the data from the cache to the hard disk.

9. The apparatus of claim 7, wherein the hard disk cache protection unit comprises:
a battery power reception module that receives battery power from the battery supply;
a cache self-refresh module that supplies battery power to the hard disk cache to maintain the cache's self-refreshing state during the power failure event; and
a hard disk write-in module that writes the data in the cache to the hard disk once an end to the power failure event is detected

10. The apparatus of claim 7, wherein the hard disk cache protection unit comprises:
a battery power reception module that receives battery power from the battery supply;
a non-volatile memory;
a cache data modify module that supplies battery power to the cache and the non-volatile memory, and writes the data in the cache to the non-volatile memory, during the power failure event;
a hard disk write-in module that writes the data in the non-volatile memory to the hard disk once an end to the power failure event is detected;

11. The apparatus of claim 7, wherein the hard disk cache protection unit supplies power to the cache through a voltage transformation circuit.

12. The apparatus of claim 7, wherein the hard disk has a hard disk interface (HDI) that conforms to an industry standard, and wherein one of the wires of the industry standard HDI is utilized as the battery power input wire, and wherein a battery power voltage placed on the battery power input wire is less than or equal to a voltage of the input wire as defined by the industry standard.

13. The apparatus of claim 12, wherein the industry standard HDI is an Advanced Technology Attachment (ATA), Serial Advanced Technology Attachment (SATA), Small Computer System Interface (SCSI), Serial Attached SCSI (SAS), or Fiber Channel (FC) interface.

14. A hard disk drive, comprising a hard disk and a controller, wherein the controller comprises a hard disk cache and a hard disk power failure protection apparatus;
wherein the hard disk power failure protection apparatus is connected to an external battery supply through a battery power input wire of the controller, and supplies power from the external battery supply to the hard disk cache during a power failure event that prevents power from reaching at least a portion of the hard disk drive.

15. The hard disk drive of claim 14, wherein the hard disk power failure protection apparatus comprises a hard disk power monitoring unit that monitors hard disk power and triggers a hard disk cache protection unit upon detection of the power failure event,
wherein the hard disk cache protection unit supplies power from a connected battery supply to the hard disk cache upon receiving a power failure signal from the power monitoring unit and performs data protection for the cache.

16. The hard disk drive of claim 15, wherein the hard disk protection unit performs data protection for the cache by maintaining either keeping a self-refreshing state of the hard disk cache active or writing the data in the cache to a separate non-volatile memory.

17. A hard disk power failure protection system comprising a battery supply and a hard disk drive, wherein the hard disk drive is connected to the battery supply through a battery power input wire, and includes a hard disk power failure protection apparatus, the hard disk power failure protection apparatus supplying power from the battery supply to the hard disk cache during a power failure event.

18. The hard disk power failure protection system of claim 17, wherein the hard disk power failure protection apparatus comprises a hard disk power monitoring unit that monitors hard disk power and triggers a hard disk cache protection unit upon detection of a power failure event that prevents power from reaching at least a portion of the hard disk drive,
wherein the hard disk cache protection unit supplies power from a connected battery supply to the hard disk cache upon receiving a power failure signal from the power monitoring unit and performs data protection for the cache.

19. The hard disk power failure protection system of claim 18, wherein the hard disk protection unit performs data protection for the cache by maintaining either keeping a self-refreshing state of the hard disk cache active or writing the data in the cache to a separate non-volatile memory.
